(19) United States
(12) Patent Application Publication
(10) Pub. No.: US 2003/0168572 A1
(43) Pub. Date: Sep. 11, 2003

(54) Adjustable rear view imaging assembly

(76) Inventors: Fred Scheuble, Lake Hiawatha, NJ (US); Richard Wagner, Toms River, NJ (US)

Correspondence Address: Ward & Olivo, Suite 300, 382 Springfield Avenue, Summit, NJ, 07901, US

(21) Appl. No.: 10/090,897

(22) Filed: Mar. 5, 2002

(51) Int. Cl. B60R 1/02

(52) U.S. Cl. 248/481; 248/479

(57) ABSTRACT

The invention disclosed provides an improved rear view imaging system. The invention discloses a system comprising a reflective imaging means and means for mounting to a solid surface, such as a desk or computer monitor. The invention maximizes the possible field of view by providing multi-directional rotation of the imaging and mounting members. Further, multiple means for coupling and mounting are contemplated.

### FIELD OF THE INVENTION

This invention relates generally to rear view imaging systems, and in particular, to a fully adjustable rear view imaging device for use with a solid structure, such as a computer monitor. Furthermore, multiple means of mounting and placement are contemplated.

### BACKGROUND OF THE INVENTION

Widespread computer use has introduced areas for innovative product expansion. A number of devices which have been used in other areas for many years are being adapted for use in conjunction with computers and computer components. One example is rear view imaging systems developed for use with a computer monitor.

Computers are an essential component of everyday life in today's world and they have made communication, storing and transferring information easier than ever before. However, entrusting so much information to computers has generated concern for the security and confidentiality of information stored in computer systems and displayed on computer monitors. As a result, numerous methods have been designed to improve the security and confidentiality of information stored in and viewed on computers.

One method developed is encryption, applied within software programs, to secure data stored in a computer's memory and/or transmitted to other computers. Data and programs are stored in “encrypted” code to prevent unauthorized individuals from accessing the encrypted information.

Another method developed to protect the security of information was the screen saver. When a computer becomes idle for a pre-selected length of time, a design will cover the entire screen preventing anyone from viewing any information that was left on the computer screen. The screen saver can also require a password for removal.

Additional security measures have been developed for Internet use and traffic, such as firewalls and “IPSEC”. A firewall limits the type of connectivity allowed between different networks. It is a computer, router or other communications device which filters access to a protected network. Usually, firewalls prevent unwarranted intrusion from the Internet, without affecting access to members of the network. However, firewalls can also be used as an access control measure within a network, allowing Internet access only to certain people within the organization. Many firewalls now contain features to control, authenticate and secure users who want to access a company's internal data from the Internet. Additionally, firewalls can be used to protect mainframe or other central resources from general access within an organization or to ensure confidentiality of information passing across networks.

IPSEC (Internet Protocol Security) deals mostly with the integrity and privacy of information flowing between computers. IPSEC refers to a set of standards developed by the Internet Engineering Task Force (IETF) to solve two problems: host-to-host authentication and encryption. Host-to-host authentication lets one host verify that it is talking to another particular host. It prevents host impersonation. Encryption prevents the unauthorized viewing of traffic going between machines.

Despite the aforementioned common security measures, individuals still encounter the risk of compromising confidentiality while they input information. None of the previously-mentioned security measures adequately address this problem. During use on a computer, an individual's back may face an office or open area. The computer user may not be fully aware of individuals passing behind him or her, or standing in the vicinity with the ability to view the information displayed on the computer monitor. Additionally, individuals who share office space with others may be concerned about whether co-workers are viewing the information on their screen.

A computer user working in a common area or office may also be distracted by noise in the surrounding area. Often an individual, while working on a computer, will hear voices, or other sounds behind him/her and turn around to view the situation, possibly breaking concentration. It would be beneficial for computer users in open environments to posses a means to view and assess a situation in the surrounding area quickly and effectively, without moving.

With increasing usage of visual forms of remote communication, such as videoconferencing, a growing number of computer users have become concerned with their appearance while sitting at their computers. During a videoconference, a video camera records the computer user, whose image is shown to other conference participants. Video cameras tend to cause individuals to become anxious and intimidated. Individuals may wish to review their appearance prior to the conference but may not have sufficient time to leave the area. A close mirror or imaging device would provide a videoconference participant the ability to quickly and efficiently review their appearance and thus lessen anxiety.

There exists a need to develop a rear view imaging apparatus for use in viewing the area behind a computer user. The easily visible assembly of the present invention permits a computer user to monitor the surrounding area, which is particularly useful when an individual is working with confidential information. In addition, a mirror that would allow computer users to monitor the surrounding area would heighten awareness and eliminate the need to turn around. Such a device would further be advantageous for an individual to quickly inspect their appearance whenever desiderated.

For years, mirror assemblies have been used in conjunction with a variety of devices to enable user's to increase their field of view. Some of the most effective and well-known assemblies allow for maximum adjustability and rotation and provide users with their optimum field of view.

The most prominent use of rear view mirror assemblies is on vehicles. These rear view mirror assemblies were designed to maximize a driver's field of view behind his or her vehicle. To achieve the ideal field of view for a driver, the horizontal and vertical placement of the driver's eyes must be contemplated. Research has shown that 95 percent of driver's eyes are located within a specific region, which is of generally elliptical shape in the vertical plane and also somewhat elliptical in the horizontal plane. The concept of the driver's “eyellipse” has been devised to create an effective vehicle design with the placement of the driver's eyes within the specified region. This concept specifies the overall distribution of eye position resulting from variations of individual's leg length and body length.

However, even within the “eyellipse,” there is considerable variability in the position of drivers' eyes. Conventionally, the assemblies facilitate horizontal and vertical adjustments to compensate for the possible variability in optimal field of view. Additionally, the assembly tends to include a means for rotation. These adjustability factors enable all drivers to achieve their optima field of view whether or not their eyes fall within the eyellipse, thus exemplifying the importance of adjustability in imaging assemblies.

Mirror assemblies relying on maximum adaptability have also been used on bicycles, police sticks and hunting guns. Mirror assemblies secured to bicycles are similar to those used in vehicles, they provide a view of the area behind the rider. On a police stick, a mirror assembly allows an officer to peer around a corner without being noticed. When coupled to a hunting gun, a mirror assembly allows the hunter to maximize visibility of the prey in a variety of directions. Adjustability and rotation of all of these mirror assemblies are essential components for maximizing the obtainable field of view.

### SURVEY OF PRIOR ART

In order to provide background information so that the invention may be completely understood and appreciated in its proper context, reference may be made to a number of patents and publications:

Freebairn U.S. Pat. No. D345,655 depicts an ornamental mirror assembly design for mounting to the top of a computer monitor. The mirror may be mounted in alignment with the top or side of a computer monitor or similar device. Freebairn teaches of a mirror assembly adjustable strictly along the coordinate x-axis (vertical) and y-axis (horizontal). Freebairn's mirror allows only limited rotation; it does not achieve the full multi-planar rotation available with different mounting such as ball and socket devices. Freebairn is also limited by the restricted movement of the means for coupling said mirror to a computer monitor. Unlike the present invention, the coupling means permanently mount the mirror to the computer monitor or other solid surface and do not permit any adjustments along any axis.

Both Plantz U.S. Pat. No. D410,150 and Newman U.S. Pat. No. D412,893 depict ornamental mirror designs. These designs allow for only limited rotation and placement adaptability. The issues of security and means for monitoring a surrounding area are not addressed.

Tichenor U.S. Pat. No. 5,130,856 depicts a mirror assembly mountable to a computer. The system comprises one mirror positioned to reflect an image from a computer monitor screen and a second mirror, which is positioned to reflect the image reflected by the first mirror towards the eyes of a viewer. The second mirror is positioned in proximity to the keyboard thus allowing the user to comfortably view the keyboard and monitor screen simultaneously. Tichenor addresses the desire to concurrently view the keyboard and computer screen, yet does not allow viewing the computer user or surrounding area. Unlike the present invention, this computer mirror assembly does not remedy any security concerns, or address a computer user's possible desire to inspect their appearance.

Baumgarten U.S. Pat. No. 5,940,229 depicts a mirror assembly mounted to an upright stand on top of a computer monitor. The mirror is directed to the area in front of the computer. This bulky, awkward mirror assembly, possibly covering a camera, is concerned primarily with the ability of a user to view their appearance. The field of view available to the computer user is strictly limited by the assembly's small range of adaptability. For example, when the camera located behind the mirror is recording it would be directed at the computer user with the mirror conforming to the position of the camera. The computer user would not be able to obtain an extensive view of the area behind them. Further, with the incorporation of a camera the adaptability of the assembly is limited to only slight rotation along the x (horizontal) and y (vertical) axes. The assembly does not permit any horizontal or vertical motion along either axis, further restricting the possible field of view.

Whitcomb U.S. Pat. No. 6,244,718 depicts a visual display monitor incorporating a mirror, which provides a rear view. The imaging assembly includes a support structure to attach a reflective surface such that the surface is rotatable while maintaining a generally fixed orientation relative to the screen of the monitor. Whitcomb teaches of two means for coupling the imaging device to a monitor. The first couples the mirror directly to the corner of monitor and the second couples the mirror to a structure, which mounts to the corner of the monitor. Both devices require that the imaging assembly be located either on the corner or in proximity to the corner of the computer monitor. The invention strives to provide maximum adaptability yet limits the obtainable field of view by restricting the possible placement of the mirror. It is desirable, and accomplished by the present invention to have a rear view imaging device with maximum adaptability and the ability to be placed anywhere on a solid surface. For example, when a computer monitor is located directly below shelves, limiting the space available for a rear view imaging device, it would be advantageous for the device to be located on the side of the monitor or possibly next to the monitor on the same desk or surface. It is possible for the present invention to mounted to the top, side, front or bottom of a solid surface.

Whatever the merits, features and advantages of the above-cited references, none achieve the objectives that the present invention accomplishes. The present invention relates to a rear view assembly maximizing the obtainable field of view of a surrounding area for a computer user. The assembly incorporates a reflective viewing device, such as a mirror, with improved means of adjustability and rotation. Prior art, such as Newman, Plantz and Baumgarten, have been limited in their means for adaptability permitting only limited movement and rotation. The bulky, awkward apparatuses do not adequately address security issues or means for monitoring the surrounding area. The improved multi-directional adjustability and rotation of the present invention provides the ability to achieve their optimum field of view in almost any situation. Unlike the prior art of Whitcomb, which is restricted to corner placement of the device, the present invention comprises a removable reusable mounting means that may be positioned anywhere along the top, sides, front and bottom of a computer or a solid surface, allowing users to select their optimum location of the device.

### SUMMARY OF THE INVENTION

The present invention discloses an apparatus comprising a reflective imaging system including means for mounting to a solid surface, such as a desk or computer monitor. The invention maximizes the possible field of view by providing multi-directional rotation of the imaging and mounting members. Additionally, the reusable mounting means permits any desired alteration in the location of the device.

The reflective imaging system may comprise an assembly of a mirror component, convex or planar, with backing and mounting means including means for coupling to the computer monitor. The mirror member may be of variable size and shape, highly polished and constructed of glass, plastic or chromium. Further the mirror may be flat or beveled to provide a peripheral view possibly coupled to a metal and/or plastic backing.

The imaging means may further comprise means for securing placement of the mirror such as a roller bead edge. The backing means of the imaging component may comprise various means for coupling to the mounting means. For example, the mirror backing may incorporate two, three or more bores, corresponding to the right, middle and left of the imaging component, for securing to the mounting means. Any one bore may be selected for use providing a novel variability for maximizing the obtainable field of view. The prior art is limited to the rotation or movement of the imaging component with no alterations of location in which the imaging component is coupled to the mounting means.

The mirror backing is secured to the mounting means for coupling the mirror assembly to the computer monitor. Unlike the mounting means of Freebairn and Baumgarden, the mounting means of the present invention may comprise any variety of means, such as a ball and socket, round swivel or adjustable extended arm, providing multi-planar adjustability. The mounting means supply a multi-directional rotation and movement and further allow for a wide variety of possible placements for the imaging device, including varying distances from the computer monitor.

The mounting means comprise a means for coupling the assembly to a solid structure, such as using double stick tape or other removable means. Thus, the mounting means is not permanently located in any one position, which will allow the user to change the location of the device whenever a change is desired. For example, an individual may have a computer monitor on the left side of the desk with the mirror device located on the upper right of the front side of the monitor. If the computer or desk is moved to a different location, it may be desirable to move the location of the mirror device to the middle left of the front side of the monitor. The flexibility of the mounting means would allow a user to mount the mirror assembly to the top, side, front or bottom of a solid surface. The present invention, possibly with double stick adhesive as a means for coupling to a solid surface, would permit a user to simply apply a small force to remove the assembly and secure it in a new location by again simply applying force.

It is an objective of the present invention to provide a rear view imaging means for monitoring a surrounding area.

Another objective of the present invention is to provide a means for a user to inspect their appearance.

An additional objective of the present invention is to include means for multi-directional rotation and adjustability.

Yet another objective of the present invention is to include adjustable means for mounting the apparatus to a solid structure.

A further objective of the present invention is for the invention to be adaptable for variously sized and shaped mirrors.

Still another objective of the present invention is to include various types of mounting means.

An objective of the present invention is to comprise a reusable means for coupling mounting means to a solid surface.

### BRIEF DESCRIPTION OF FIGURES

FIG. 1 depicts a perspective side portrayal of a ball and socket mounting means of a preferred embodiment of the present invention.

FIG. 2 depicts a front, bottom and side perspective portrayal of the backing means for corresponding swivel mounting means in an alternative embodiment of the present invention.

FIG. 2A depicts a posterior and side perspective portrayal of the backing means for corresponding swivel mounting means in an alternative embodiment for the present invention.

FIG. 3 depicts a front perspective portrayal of the extended arm mounting means in an alternative embodiment of the present invention.

FIG. 3A depicts a front and side perspective portrayal of the rotational head of the extended arm mounting means of an alternative embodiment of the present invention.

FIG. 3B depicts a side perspective portrayal of the extended arm component of the extended arm mounting means in an alternative embodiment of the present invention.

FIG. 3C depicts a top and side perspective portrayal of the mounting component of the extended arm mounting means in an alternative embodiment of the present invention.

### DETAILED DESCRIPTION OF PREFERRED EMBODIMENTS

A further understanding of the present invention can be obtained by reference to a preferred embodiment as set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, but merely to clarify and exemplify the invention.

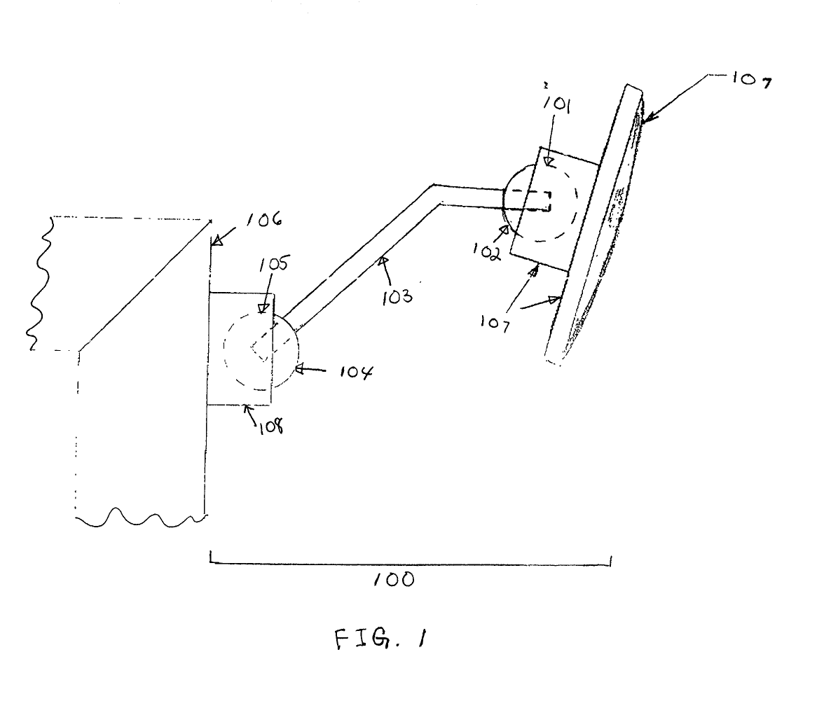

FIG. 1 depicts a preferred embodiment of the present invention with ball and socket mounting means 100. The imaging member backing 107 may comprise a socket 101 for corresponding ball protrusion 102 of arm 103. Arm 103 may be straight or bent at any of a variety of angles. The opposing end of arm 103 embodies an additional ball protrusion 104 for corresponding socket 105 for mounting to solid structure, such as a computer monitor 106. Additionally the mounting means incorporates a means (not shown) for securing location of the mirror assembly 108 to solid structure.

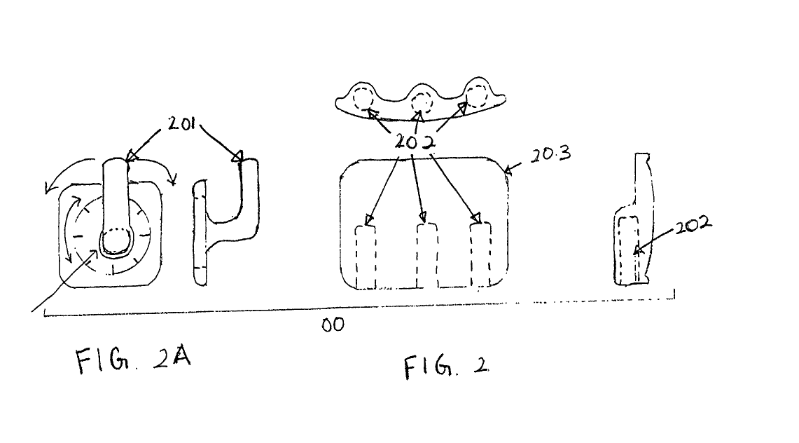

FIG. 2 depicts a bottom, front and side perspective portrayal of the backing means of an alternative embodiment of the present invention with round swivel 201 mounting means 200. The backing of the imaging assembly 203 comprises a plurality of round mounting vertical bores 202. The bores 202 may be variably located along the imaging backing 203. The bores 202 should correspond in size to a cylindrical protrusion of the mounting means 201. Any of the plurality of holes 202 may slide onto the cylindrical protrusion altering the axis position on which the imaging assembly rotates. The mirror may swivel or rotate along the axis to an optimum location. The mounting means 200 may be coupled to the computer monitor by double-stick tape or similar means.

FIG. 2A depicts a posterior and side perspective portrayal of the alternative embodiment with the round swivel 201 mounting means 200. The bores 202 in imaging backing correspond to the diameter of mounting means 201. The convex imaging assembly is secured to the backing 203 by a beaded roller edge.

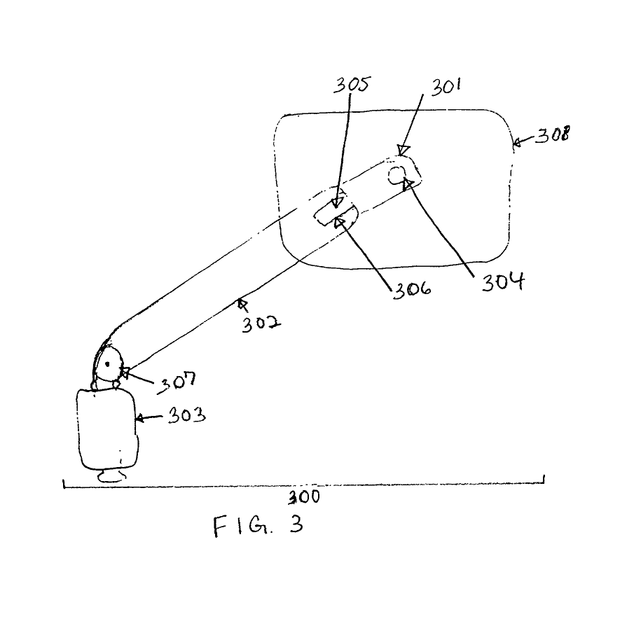

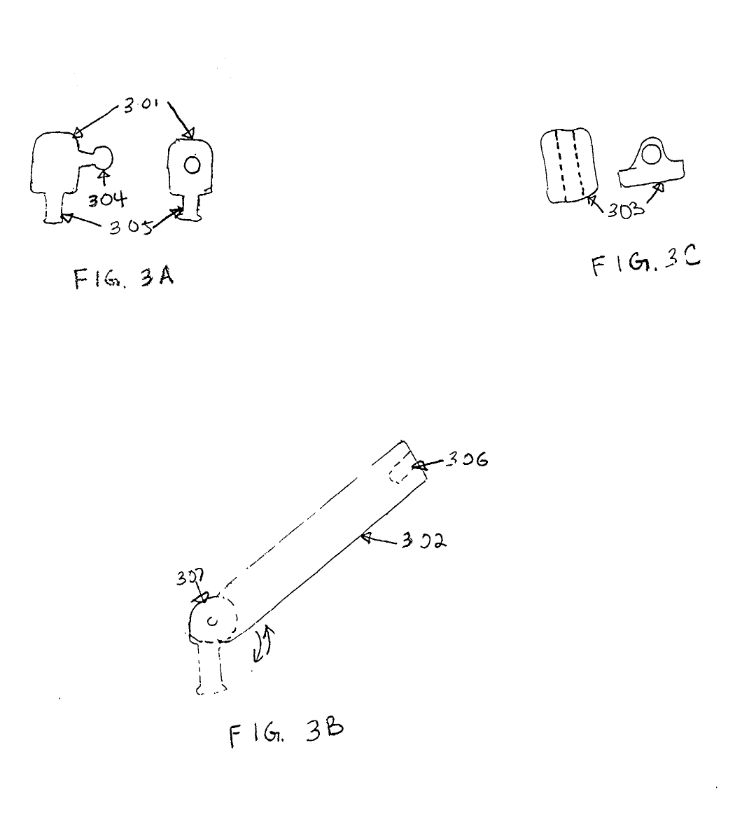

FIG. 3 depicts a front perspective portrayal of an alternative embodiment of the present invention with extended pivotal arm assembly 300. The extended pivotal arm assembly comprises a rotational head 301, an extended arm 302 and swivel mounting means 303, depicted in FIG. 3A, FIG. 3B, and FIG. 3C respectively. The rotational head 301 is coupled to the reflective viewing assembly 308 by an adjustable means, such as a ball and socket. The rotational head comprises a ball 304 to fit securely in the corresponding socket (not shown) of the mirror assembly. The rotational head 301 also embodies a protruding cylindrical feature 305 that couples to a corresponding aperture 306 in the extended arm 302 providing 360-degree rotational capability of the head 301. The opposing end of the extended arm 302 is fixed to the swivel mounting means 403, possibly through rotation joint 307. The rotational joint 307 allows for rotation about the coordinate z-axis. The swivel mounting means 303 is coupled to the solid structure to permit 360-degree rotation about the coordinate y-axis. The mounting means may be secured to a solid surface by an easily reusable means, such as double-stick tape.

I claim:

1. An improved rearview imaging system comprising:
an imaging component for reflecting entities in the anterior direction of said imaging component;
mounting means for mounting said rearview imaging system to a flat solid surface; and
backing means for coupling said imaging component to said mounting means, wherein said backing means comprises means for securing the position of said imaging component.

2. An improved rearview imaging system according to claim 1, wherein said imaging component comprises a mirror.

3. An improved rearview imaging system according to claim 2, wherein said mirror is flat.

4. An improved rearview imaging system according to claim 2, wherein said mirror is beveled.

5. An improved rearview imaging system according to claim 2, wherein said mirror is planar.

6. An improved rearview imaging system according to claim 2, wherein said mirror is convex.

7. An improved rearview imaging system according to claim 1, wherein said imaging component is secured in place to said backing means by a roller bead edge.

8. An improved rearview imaging system according to claim 1, wherein said backing means permits rotation along a multitude of axes.

9. An improved rearview imaging system according to claim 1, wherein said backing means permits movement in a multitude of directions.

10. An improved rear view imaging system according to claim 1, wherein said backing means of said imaging component comprises a plurality of bores, wherein one of said bores is used for coupling to said mounting means.

11. An improved rear view imaging system according to claim 1, wherein said mounting means comprises a ball and socket means for coupling said mounting means to said backing means of said imaging component.

10. An improved rearview imaging system according to claim 1, wherein said mounting means comprises a round swivel means for coupling said mounting means to said backing means of said imaging component.

11. An improved rearview imaging system according to claim 1, wherein said mounting means comprises an extended arm means for coupling said mounting means to said backing means of said imaging component.

12. An improved rearview imaging system according to claim 1, wherein means for coupling said mounting means to said flat solid surface is reusable.

13. An improved rearview imaging system according to claim 1, wherein said mounting means permits rotation along a multitude of axes.

14. An improved rearview imaging system according to claim 1, wherein said mounting means permits movement in a multitude of directions.

15. An improved rearview imaging method comprising:
reflecting entities in the anterior direction of an imaging component;
providing mounting means for mounting said imaging system to a flat solid surface;
providing a backing means secured to said imaging component for coupling to said mounting means, wherein said backing means permits multi-directional rotation and adjustment; and
securing placement of said imaging component to said backing means.

16. An improved rearview imaging method according to claim 15, wherein said imaging component comprises a mirror.

17. An improved rearview imaging method according to claim 16, wherein said mirror is flat.

18. An improved rearview imaging method according to claim 16, wherein said mirror is beveled.

19. An improved rearview imaging method according to claim 16, wherein said mirror is planar.

20. An improved rearview imaging method according to claim 16, wherein said mirror is convex.

21. An improved rearview imaging system according to claim 15, wherein said imaging component is secured in place to said backing means by a roller bead edge.

22. An improved rearview imaging system according to claim 15, wherein said backing means permits rotation along a multitude of axes.

23. An improved rearview imaging system according to claim 15, wherein said backing means permits movement in a multitude of directions.

24. An improved rear view imaging system according to claim 15, wherein said backing means of said imaging component comprises a plurality of bores, wherein one of said bores is used for coupling to said mounting means.

25. An improved rear view imaging system according to claim 15, wherein said mounting means comprises a ball and socket means for coupling said mounting means to said backing means of said imaging component.

26. An improved rearview imaging system according to claim 15, wherein said mounting means comprises a round swivel means for coupling said mounting means to said backing means of said imaging component.

27. An improved rearview imaging system according to claim 15, wherein said mounting means comprises an extended arm means for coupling said mounting means to said backing means of said imaging component.

28. An improved rearview imaging system according to claim 15, wherein means for coupling said mounting means to said flat solid surface is reusable.

30. An improved rearview imaging system comprising:
an imaging component for reflecting entities in the area in the anterior direction of said imaging component, wherein said imaging component is adjustable;
mounting means for mounting said rearview imaging system to a flat solid surface, wherein said mounting means permits multi-directional rotation and adjustment; and
backing means of said imaging component for coupling said imaging component to said mounting means, wherein said backing means comprises means for securing the position of said imaging component, and further wherein said backing means permit multi-directional rotation and adjustment.

31. An improved rearview imaging system according to claim 30, wherein said imaging component comprises a mirror.

32. An improved rearview imaging system according to claim 31, wherein said mirror is flat.

33. An improved rearview imaging system according to claim 31, wherein said mirror is beveled.

34. An improved rearview imaging system according to claim 31, wherein said mirror is planar.

35. An improved rearview imaging system according to claim 31, wherein said mirror is convex.

36. An improved rearview imaging system according to claim 30, wherein said imaging component is secured in place to said backing means by a roller bead edge.

37. An improved rear view imaging system according to claim 30, wherein said backing means of said imaging component comprises a plurality of bores, wherein one of said bores is used for coupling said imaging component to said mounting means.

38. An improved rear view imaging system according to claim 30, wherein said mounting means comprises a ball and socket means for coupling said mounting means to said backing means of said imaging component.

39. An improved rearview imaging system according to claim 30, wherein said mounting means comprises a round swivel means for coupling said mounting means to said backing means of said imaging component.

40. An improved rearview imaging system according to claim 30, wherein said mounting means comprises an extended arm means for coupling said mounting means to said backing means of said imaging component.

41. An improved rearview imaging system according to claim 30, wherein means for coupling said mounting means to said flat solid surface is reusable.
